(19) United States
(12) Patent Application Publication
(10) Pub. No.: US 2009/0100095 A1
(43) Pub. Date: Apr. 16, 2009

(54) Systems and methods for reinsurance utilizing epigenetic information

(76) Inventors: Edward K.Y. Jung, Bellevue, WA (US); Roderick A. Hyde, Redmond, WA (US); Jordin T. Kare, Seattle, WA (US); Eric C. Leuthardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(21) Appl. No.: 11/986,966

(22) Filed: Nov. 27, 2007

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.

(51) Int. Cl. G06F 17/30; G06Q 10/00; G06Q 40/00

(52) U.S. Cl. 707/104.1; 705/7; 705/4; 707/E17.044

(57) ABSTRACT

A method may include receiving epigenetic information associated with at least one individual. The epigenetic information may be utilized to calculate a risk. A least a portion of the risk may be transferred utilizing the epigenetic information.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.pov/web/offices/com/sol/og/2003/week11/ patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method includes receiving epigenetic information associated with at least one individual. The epigenetic information may be utilized to calculate a risk. At least a portion of the risk may be transferred. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A system includes a means for receiving a first set of epigenetic information associated with at least one individual. The system may further include a means for receiving a second set of epigenetic information associated with the at least one individual. In addition to the foregoing, other system aspects are described in the claims, drawings, and text forming a part of the present disclosure.

A system includes circuitry for receiving epigenetic information associated with at least one individual. The system may further include circuitry for calculating a risk utilizing the epigenetic information. The system may further include circuitry for transferring at least a portion of the risk utilizing the epigenetic information. In addition to the foregoing, other system aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an exemplary environment in which one or more technologies may be implemented.

FIG. 2 illustrates an operational flow representing example operations related to utilizing epigenetic information to calculate a risk for transferring at least a portion of the calculated risk.

FIG. 3A illustrates an alternative embodiment of the operational flow of FIG. 2.

FIG. 3B illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

FIG. 11 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

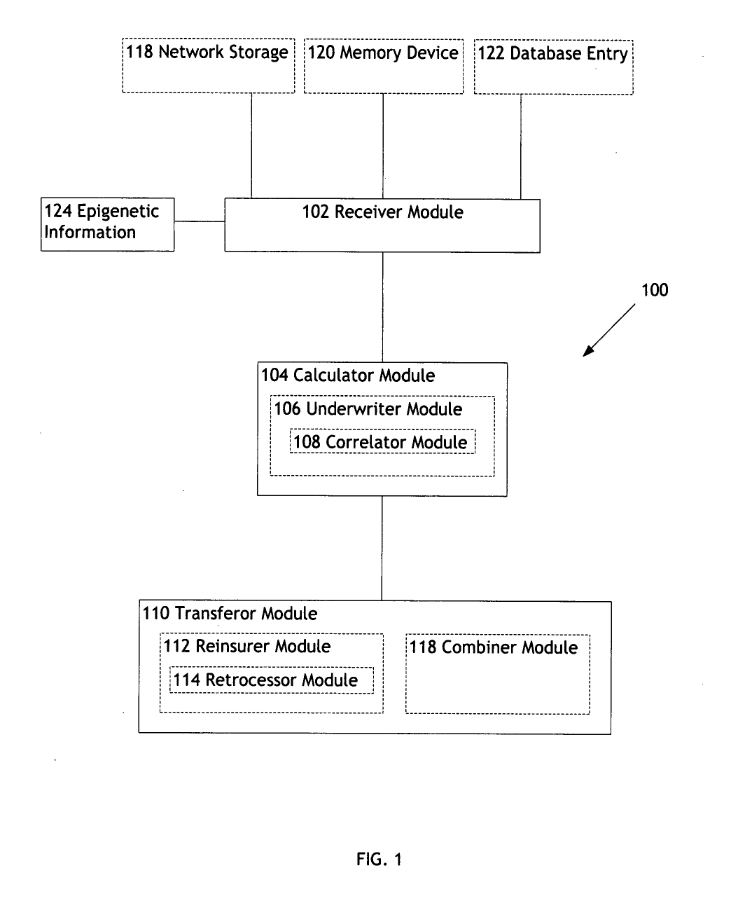

Referring to FIG. 1, a system 100 for utilizing epigenetic information to calculate a risk for transferring at least a portion of the calculated risk is illustrated. The system 100 may include a receiver module 102, a calculator module 104, and/or a transferor module 110. The receiver module 102 may receive epigenetic information associated with an individual, such as information regarding a methylation status for that individual. The calculator module 104 may utilize epigenetic information (e.g., an individual's methylation status) to calculate a risk. Finally, the transferor module 110 may transfer a portion of a risk that has been calculated utilizing epigenetic information (e.g., a risk calculated by examining an individual's methylation status).

The calculator module 104 may include an underwriter module 106. The underwriter module 106 may underwrite a risk at least partially based on epigenetic information (e.g., at least partially based on a specific methylation status for an individual indicating a predetermined condition). The underwriter module 106 may further include a correlator module 108. The correlator module 108 may correlate epigenetic information to a risk factor at least partially based on the epigenetic information.

The transferor module 110 may include a reinsurer module 112. The reinsurer module 112 may reinsure a transferred risk, such as a risk at least partially transferred from one insurance provider to another insurance provider. The reinsurer module 112 may further include a retrocessor module 114. The retrocessor module 114 may pass on a reinsurer's risk to a second reinsurer (e.g., against the payment of a premium).

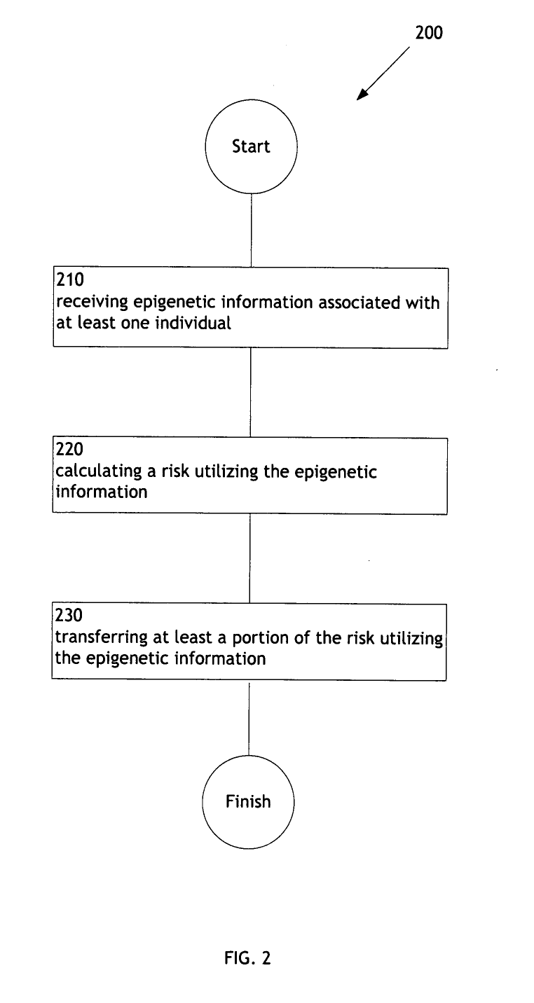

FIG. 2 illustrates an operational flow 200 representing example operations related to utilizing epigenetic information to calculate a risk for transferring at least a portion of the calculated risk. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200 moves to a receiving operation 210, where epigenetic information associated with at least one individual may be received. For example, as shown in FIG. 1, epigenetic information 124 may be received by the receiver module 102. In one specific embodiment, the receiver module 102 may receive epigenetic information from network storage 118, such as information stored in a database and served up from a server, or the like. Alternatively, epigenetic information may be obtained from a memory device 120, such as a flash drive, a remote memory storage device, or the like. It will be appreciated that epigenetic information associated with at least one individual may be obtained in a variety of ways from a number of different media without departing from the scope of the present disclosure. Further, the information may be provided in a variety of formats. For example, in one specific instance, the epigenetic information is provided in the form of a database entry 122. Alternatively, the epigenetic information may be provided in the form of an Extensible Markup Language (XML) document, or the like.

Then, in a calculating operation 220, a risk may be calculated utilizing the epigenetic information. For example, as shown in FIG. 1, the calculator module 104 may calculate a risk utilizing the epigenetic information obtained via the receiver module 102. For instance, in one specific embodiment, epigenetic information including a specific methylation status indicating a predetermined condition is utilized to calculate an insurance risk for an individual. It will be appreciated that while the epigenetic information may be taken into account when calculating the risk, other factors may be accounted for as well, including information from an actuarial table, and the like.

Then, in a transferring operation 230, at least a portion of the risk is transferred utilizing the epigenetic information. For example, as shown in FIG. 1, the transferor module 110 may transfer a portion of a risk to another entity. In one specific example, a portion of a risk for an insured individual is passed on from one insurance provider to another.

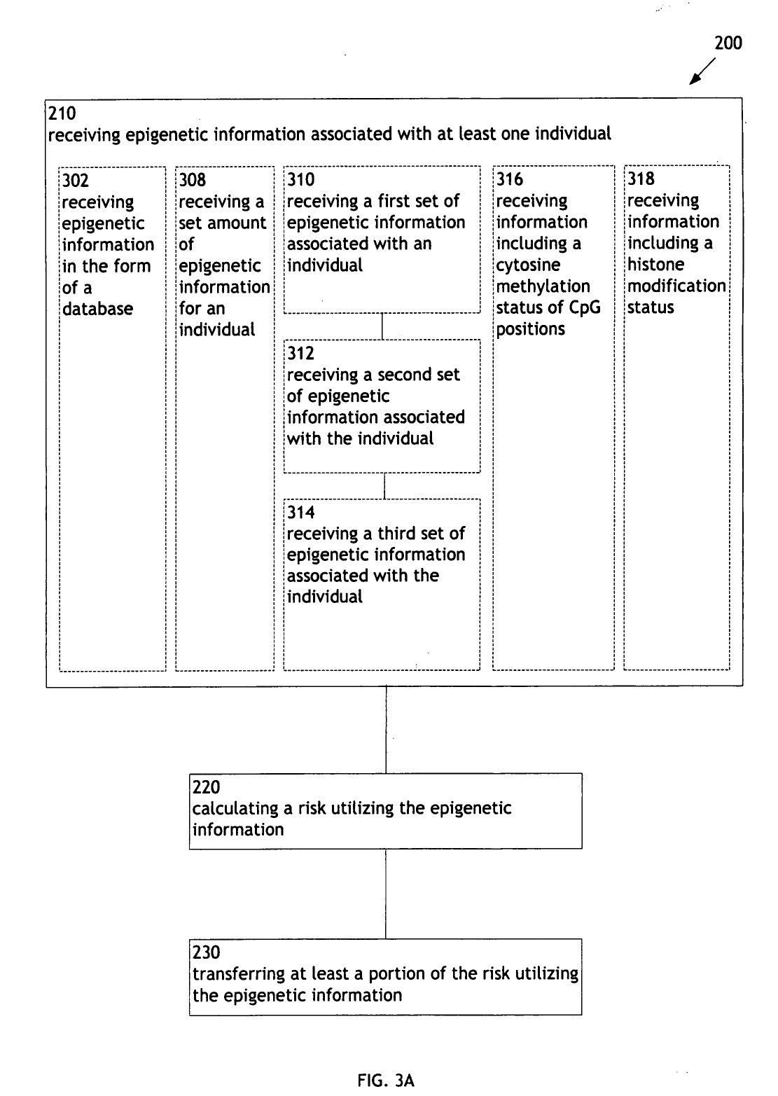

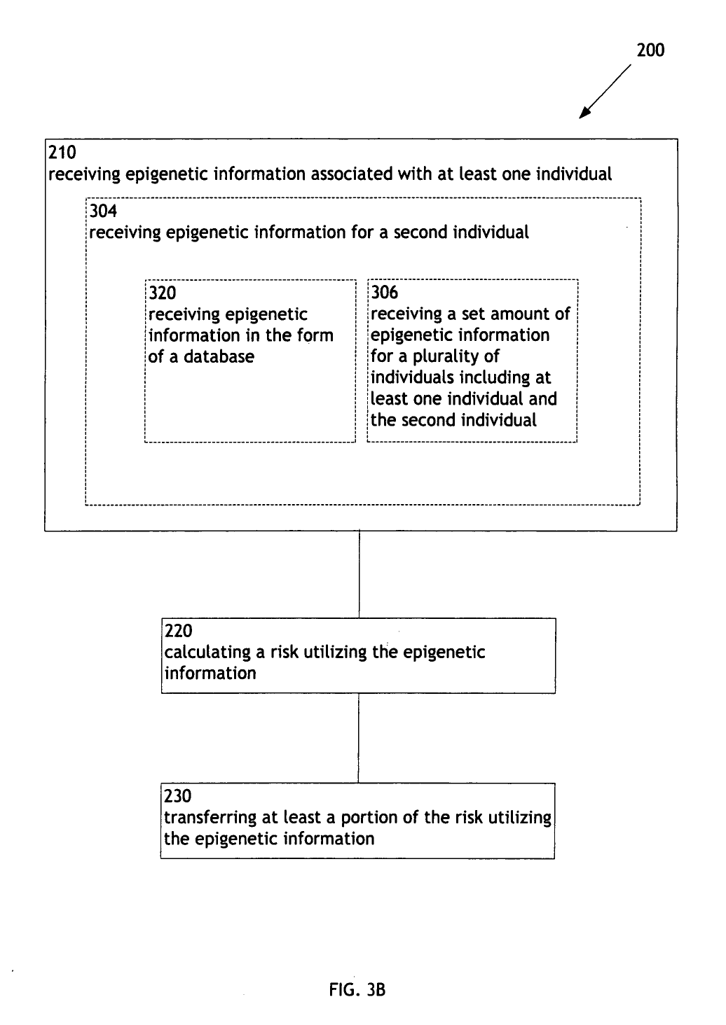

FIG. 3A illustrates alternative embodiments of the example operational flow 200 of FIG. 2. FIG. 3 illustrates example embodiments where the receiving operation 210 may include at least one additional operation. Additional operations may include an operation 302, an operation 308, an operation 310, an operation 312, an operation 314, an operation 316, and/or an operation 318.

At the operation 302, epigenetic information in the form of a database may be received. For example, as shown in FIG. 1, the receiver module 102 may receive a database entry 122 including epigenetic information. In a specific instance, receiver module 102 receives a database entry 122 including epigenetic information. At the operation 308, a set amount of epigenetic information for an individual may be received. For example, as shown in FIG. 1, the receiver module 102 may receive a set amount of epigenetic information for an individual. In a specific instance, receiver module 102 receives a set of five thousand entries from a database entry 122 including epigenetic information.

At the operation 310, a first set of epigenetic information associated with an individual may be received. For example, as shown in FIG. 1, the receiver module 102 may receive from the memory device 120 a first set of epigenetic information for an individual. The first set of epigenetic information may be received in the form of a batch of epigenetic information associated with one or more individuals. In a specific instance, receiver module 102 receives from memory device 120 a first set of epigenetic information associated with a specific individual. Then, at the operation 312, a second set of epigenetic information associated with at least one individual may be received. For example, as shown in FIG. 1, and continuing from the previous example, receiver module 102 may receive from the memory device 120 a second batch of epigenetic information associated an individual. The second set of epigenetic information may include information collected and/or obtained subsequently to the collection of the first set of information. In a specific example, receiver module 102 receives a second set of epigenetic information indicating a specific histone structure modification. Further, at the operation 314, a third set of epigenetic information associated with an individual may be received. For example, as shown in FIG. 1, and continuing from the previous example, receiver module 102 may receive from the memory device 120 a third batch of epigenetic information associated with a specific individual. In a specific instance, receiver module 102 receives from the memory device 120 a third batch of epigenetic information associated with a specific individual. The third set of epigenetic information may include information collected and/or obtained subsequently to the collection of the second set of information. Additional sets of information may be received by receiver module 102 as batches or finite sets beyond the first, second, and third set of epigenetic information.

Further, at the operation 316, information including a cytosine methylation status of CpG positions may be received. For example, as shown in FIG. 1, the receiver module 102 may receive a database entry 122 including a cytosine methylation status of CpG positions. In a specific instance, receiver module 102 receives a database entry 122 including a cytosine methylation status of CpG positions for a specific individual. Further, at the operation 318, information including a histone modification status may be received. For example, as shown in FIG. 1, the receiver module 102 may receive a database entry 122 including a histone modification status for a specific individual. In a specific instance, receiver module 102 receives a database entry 122 including a histone modification status indication a likelihood of cancer for a specific individual.

FIG. 3B illustrates alternative embodiments of the example operational flow 200 of FIG. 2. FIG. 3B illustrates example embodiments where the receiving operation 210 may include at least one additional operation. Additional operations may include an operation 304, an operation 320, and/or an operation 306.

At the operation 304, epigenetic information for a second individual may be received. For example, as shown in FIG. 1, the receiver module 102 may receive epigenetic information associated with at least one person and a second person. In one specific instance, receiver module 102 receives epigenetic information associated with two individuals, John Smith and David Smith. Names used herein are meant to be exemplary only.

At the operation 320, epigenetic information for a second individual in the form of a database may be received. For example, as shown in FIG. 1, the receiver module 102 may receive epigenetic information for a second individual in the form of a database. In one specific instance, receiver module 102 receives epigenetic information in the form of a database from network storage 118 associated with two individuals, John Smith and David Smith. Names used herein are meant to be exemplary only.

At the operation 306, a set amount of epigenetic information may be received for a plurality of individuals including at least the first individual and the second individual. For example, as shown in FIG. 1, the receiver module 102 may receive a set amount of epigenetic information for at least a first individual and a second individual. In a specific instance, receiver module 102 receives from network storage 118 information related to DNA methylation for John Smith, David Johnson, and five thousand other people.

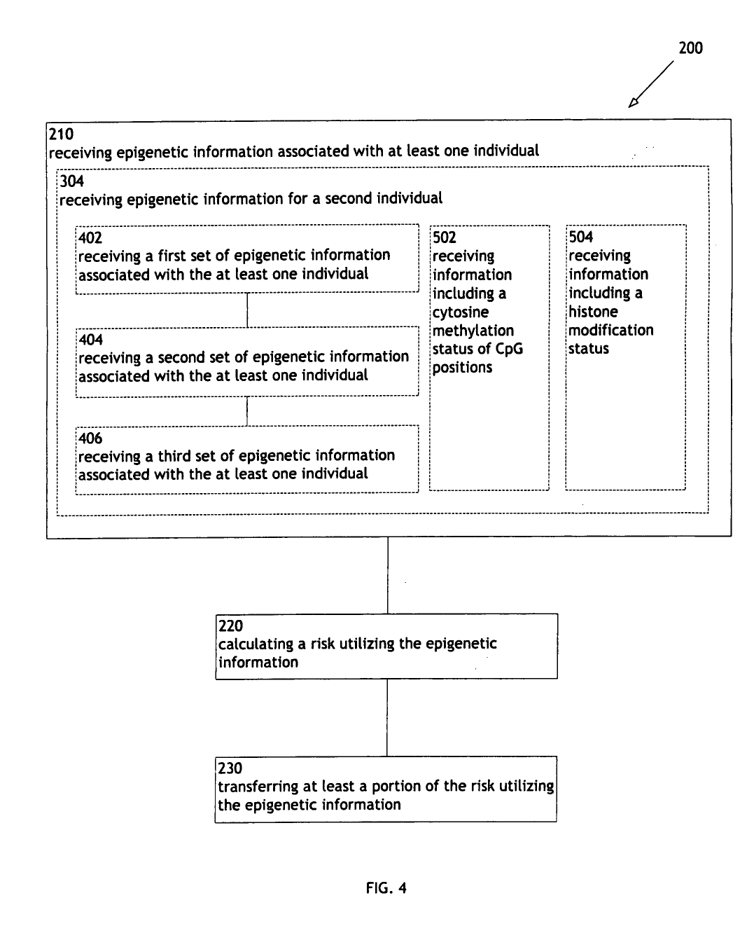

FIG. 4 illustrates alternative embodiments of the example operational flow 200 of FIG. 2. FIG. 4 illustrates example embodiments where the receiving operation 210 may include at least one additional operation. Additional operations may include an operation 402, an operation 404, an operation 406, an operation 502, and/or an operation 504.

At the operation 402, a first set of epigenetic information associated with the at least one individual may be received. For example, as shown in FIG. 1, the receiver module 102 may receive from the memory device 120 a first set of epigenetic information for a single individual or, alternatively, for a plurality of individuals, such as individuals in a predetermined population categorized by geographic residence. The first set of epigenetic information may be received in the form of a batch of epigenetic information associated with one or more individuals. Then, at the operation 404, a second set of epigenetic information associated with the at least one individual may be received. For example, as shown in FIG. 1, and continuing from the previous example, receiver module 102 may receive from the memory device 120 a second batch of epigenetic information associated with one or more individuals. The second set of epigenetic information may include information collected and/or obtained subsequently to the collection of the first set of information. Further, at the operation 406, a third set of epigenetic information associated with the at least one individual may be received. For example, as shown in FIG. 1, and continuing from the previous example, receiver module 102 may receive from the memory device 120 a third batch of epigenetic information associated with one or more individuals. The third set of epigenetic information may include information collected and/or obtained subsequently to the collection of the second set of information. Additional sets of information may be received by receiver module 102 as batches or finite sets beyond the first, second, and third set of epigenetic information.

At the operation 502, information including a cytosine methylation status of CpG positions may be received. For example, as shown in FIG. 1, the receiver module 102 may receive from the memory device 120 epigenetic information including a cytosine methylation status of CpG positions. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference.

At the operation 504, information including a status of acetylation of histone may be received. For example, as shown in FIG. 1, the receiver module 102 may receive from the memory device 120 epigenetic information including the status of acetylation of histone for a particular individual.

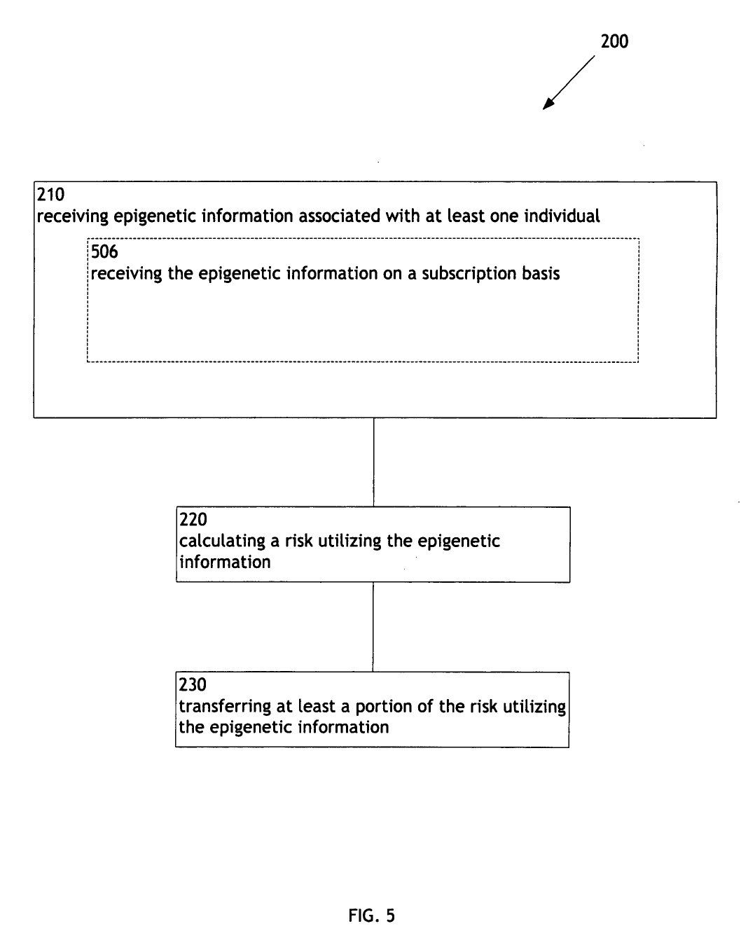

FIG. 5 illustrates alternative embodiments of the example operational flow 200 of FIG. 2. FIG. 5 illustrates example embodiments where the receiving operation 210 may include at least one additional operation. Additional operations may include an operation 502, an operation 504, and/or an operation 506.

At the operation 506, epigenetic information may be received on a subscription basis. For example, as shown in FIG. 1, the receiver module 102 may receive from network storage 118 epigenetic information on a subscription basis. A subscription may include a transaction wherein a party purchases access to a product and/or service for a period of time. For example, an insurance underwriter may purchase access to a database including epigenetic information associated with personally identifying information for one year for five thousand dollars. Further, the level of access to information may be dictated by the level/purchase price of the subscription. For instance, one subscription level may allow a subscriber to access specific epigenetic information for a number of specified individuals, while another subscription level may allow a subscriber access to general information grouped together for a variety of individuals.

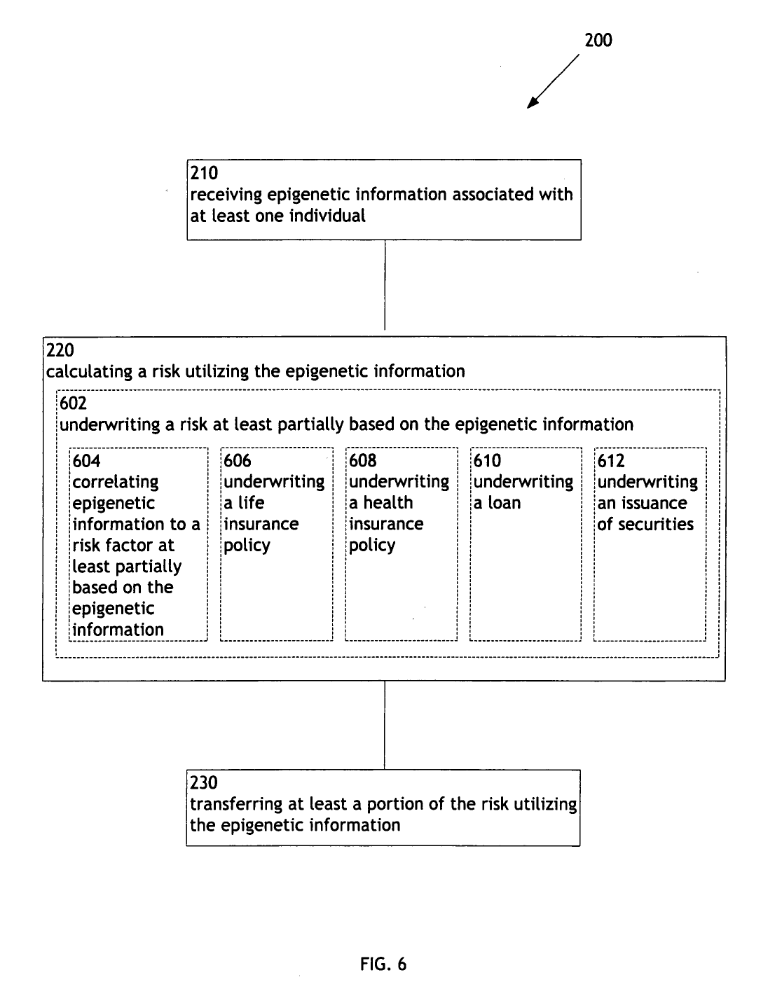

FIG. 6 illustrates alternative embodiments of the example operational flow 200 of FIG. 2. FIG. 6 illustrates example embodiments where the calculating operation 220 may include at least one additional operation. Additional operations may include an operation 602, an operation 604, an operation 606, an operation 608, an operation 610, and/or an operation 612.

At the operation 602, a risk may be underwritten at least partially based on the epigenetic information. For example, as shown in FIG. 1, the underwrite module 106 may utilize information collected by the receiver module 102 to calculate an insurance risk for an individual. Further, at the operation 604, epigenetic information may be correlated to a risk factor at least partially based on the epigenetic information. For example, as shown in FIG. 1, the correlator module 108 may correlate epigenetic information associated with one particular medical condition to a first level of risk, while correlating epigenetic information associated with another medical condition to a second level of risk. Further, at the operation 606, a life insurance policy may be underwritten. For example, as shown in FIG. 1, the underwriter module 106 may underwrite a life insurance policy for one individual utilizing the information collected regarding the first level of risk. Further, at the operation 608, a health insurance policy may be underwritten. For example, as shown in FIG. 1, the underwriter module 106 may underwrite a health insurance policy for another individual utilizing the information collected regarding the second level of risk. Still further, at the operation 610, a loan may be underwritten. For example, as shown in FIG. 1, the underwriter module 106 may underwrite a loan for one individual utilizing the information collected regarding the first level of risk. Further, at the operation 612, an issuance of securities may be underwritten. For example, as shown in FIG. 1, the underwriter module 106 may underwrite an issuance of securities for another individual utilizing the information collected regarding the second level of risk.

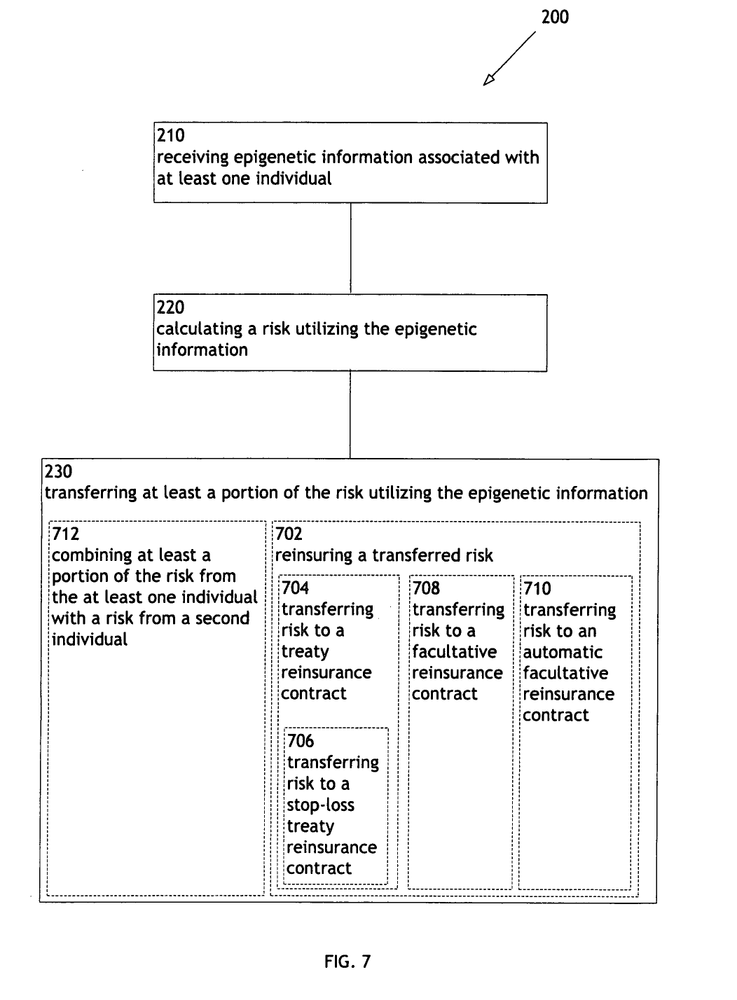

FIG. 7 illustrates alternative embodiments of the example operational flow 200 of FIG. 2. FIG. 7 illustrates example embodiments where the transferring operation 230 may include at least one additional operation. Additional operations may include an operation 712, an operation 702, an operation 704, an operation 706, an operation 708, and/or an operation 710.

At the operation 712, at least a portion of the risk from the at least one individual with a risk from a second individual may be combined. For example, as shown in FIG. 1, the combiner module 118 may merge at least a portion of the risk from the at least one individual with a risk from a second individual. Epigenetic information may or may not be known for the second individual. In one instance, combiner module 118 combines a portion of a risk from a specific individual with a known risk from a second individual even though epigenetic information regarding the second individual is not known.

At the operation 702, a transferred risk may be reinsured. For example, as shown in FIG. 1, the transferor module 110 may transfer at least a portion of a risk from one insurance provider to another for reinsurance. In an instance, transferor module 110 transfers a risk associated with a group of life insurance policies to a reinsurer. Further, at the operation 704, risk may be transferred to a treaty reinsurance contract. For example, as shown in FIG. 1, at least a portion of a risk may be transferred by the transferor module 110 from one insurance provider to another insurance provider, where the second insurance provider participates in certain sections of the first insurance provider's business as agreed to by treaty. In one example, a direct insurer transfers a risk associated with a group of health insurance policies to a reinsurer by a treaty contract. Further, at the operation 706, risk may be transferred to a stop-loss treaty reinsurance contract. For example, as shown in FIG. 1, the transferor module 110 may transfer at least a portion of a risk from a first insurer to a second insurer, where the second insurer (reinsurer) is obligated to cover any part of a total annual loss burden that exceeds an agreed deductible. In an example, transferor module 110 transfers risk from a direct insurer to a reinsurer and the reinsurer is obligated to cover all of a total annual loss burden exceeding an agreed deductible. In one specific embodiment, the agreed deductible may be defined as a percentage of the annual premium income. In another specific embodiment, the agreed deductible may be a fixed sum. Further, at the operation 708, risk may be transferred to a facultative reinsurance contract. For example, as shown in FIG. 1, the transferor module 110 may offer to transfer one or more individual risks to a reinsurer, who may accept or decline any one of the one or more individual risks offered by the transferor module 110. Further, at the operation 710, risk may be transferred to an automatic facultative reinsurance contract. For example, as shown in FIG. 1, the transferor module 110 may transfer at least a portion of a risk to a reinsurer, where an automatic facultative reinsurance contract is an agreement in which the parties establish in advance criteria for the types of risks to be reinsured which will automatically be covered by the reinsurance agreement without further underwriting by the reinsurer and at the election of the direct insurer.

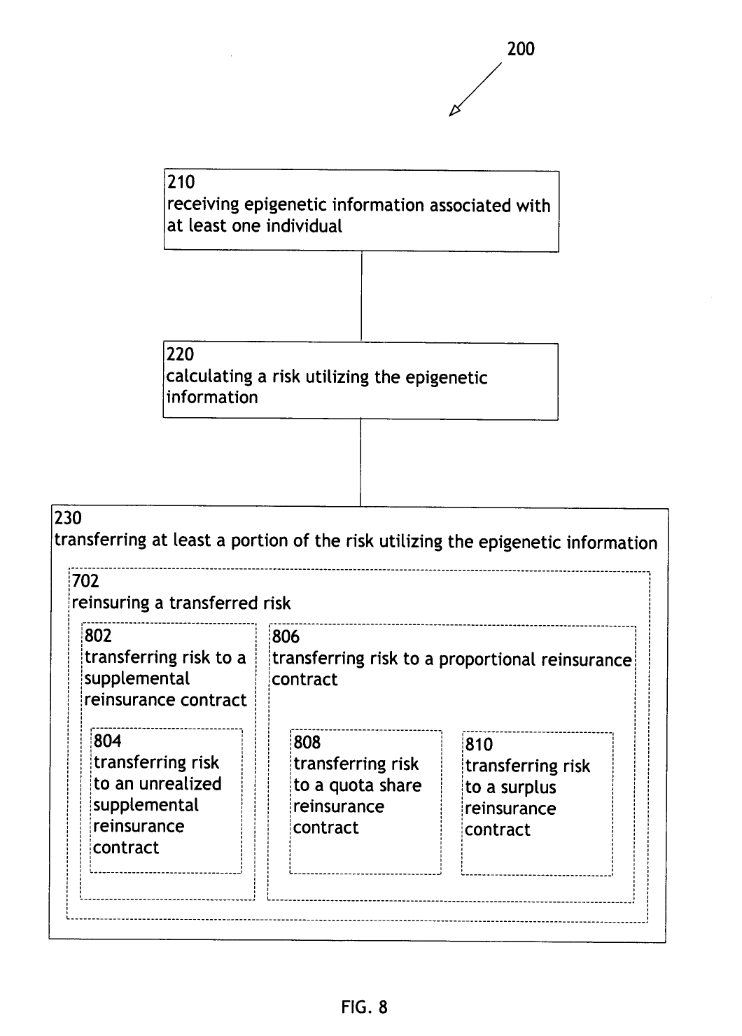

FIG. 8 illustrates alternative embodiments of the example operational flow 200 of FIG. 2. FIG. 8 illustrates example embodiments where the transferring operation 230 may include at least one additional operation. Additional operations may include an operation 802, an operation 804, an operation 806, an operation 808, and/or an operation 810. At the operation 802, risk may be transferred to a supplemental reinsurance contract. For example, as shown in FIG. 1, the transferor module 110 may transfer at least a first portion of a risk to a reinsurer under a reinsurance contract, and subsequently transfer at least a second portion of the risk to a reinsurer under the supplemental reinsurance contract. Further, at the operation 804, risk may be transferred to an unrealized supplemental reinsurance contract. For example, as shown in FIG. 1, the transferor module 110 may transfer at least a portion of a risk to a supplemental reinsurer, where an unrealized supplemental reinsurance contract covers a discrepancy between the insurer's losses and amount of reinsurance collected in connection with those losses. Further, at the operation 806, risk may be transferred to a proportional reinsurance contract. For example, as shown in FIG. 1, the transferor module 110 may transfer at least a portion of a risk to a reinsurer, where the premiums and losses are divided between the insurer and the reinsurer according to a contractually defined ratio. Further, at the operation 808, risk may be transferred to a quota share reinsurance contract. For example, as shown in FIG. 1, the transferor module 110 may transfer at least a portion of a risk to a reinsurer, where the reinsurer assumes an agree-upon fixed quota of all the insurance policies written by the direct insurer. Further, at the operation 810, risk may be transferred to a surplus reinsurance contract. For example, as shown in FIG. 1, the transferor module 110 may transfer at least a portion of a risk to a reinsurer, where the direct insurer retains all risks up to a certain amount of liability, and the reinsurer accepts the surplus (an amount exceeding the direct insurer's retention).

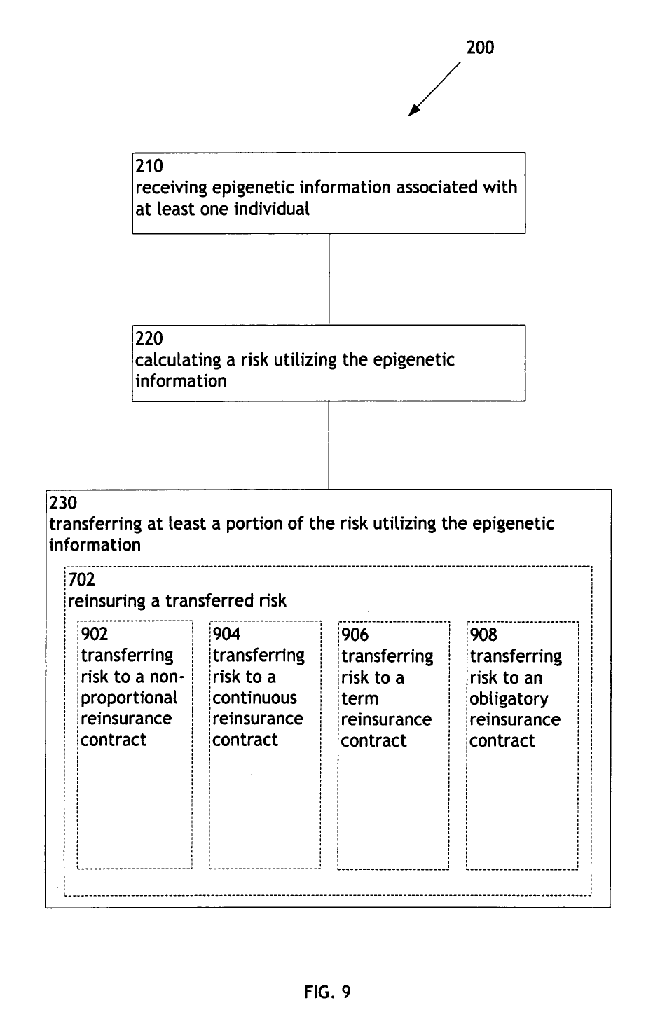

FIG. 9 illustrates alternative embodiments of the example operational flow 200 of FIG. 2. FIG. 9 illustrates example embodiments where the transferring operation 230 may include at least one additional operation. Additional operations may include an operation 902, an operation 904, an operation 906, and/or an operation 908. At the operation 902, risk may be transferred to a non-proportional reinsurance contract. For example, as shown in FIG. 1, the transferor module 110 may transfer at least a portion of a risk to a reinsurer, where there is no set/predetermined ratio for dividing the premiums between the direct insurer and the reinsurer. Further, at the operation 904, risk may be transferred to a continuous reinsurance contract. For example, as shown in FIG. 1, the transferor module 110 may transfer at least a portion of a risk to a reinsurer, where the reinsurance contract has no expiration date. Further, at the operation 906, risk may be transferred to a term reinsurance contract. For example, as shown in FIG. 1, the transferor module 110 may transfer at least a portion of a risk to a reinsurer, where the reinsurance contract has an agreed upon termination date. Further, at the operation 908, risk may be transferred to an obligatory reinsurance contract. For example, as shown in FIG. 1, the transferor module 110 may transfer at least a portion of a risk to a reinsurer, where the reinsurer is obliged to accept a contractually agreed upon share of the risk, and the direct insurer is obliged to cede a contractually agreed upon share of the risk.

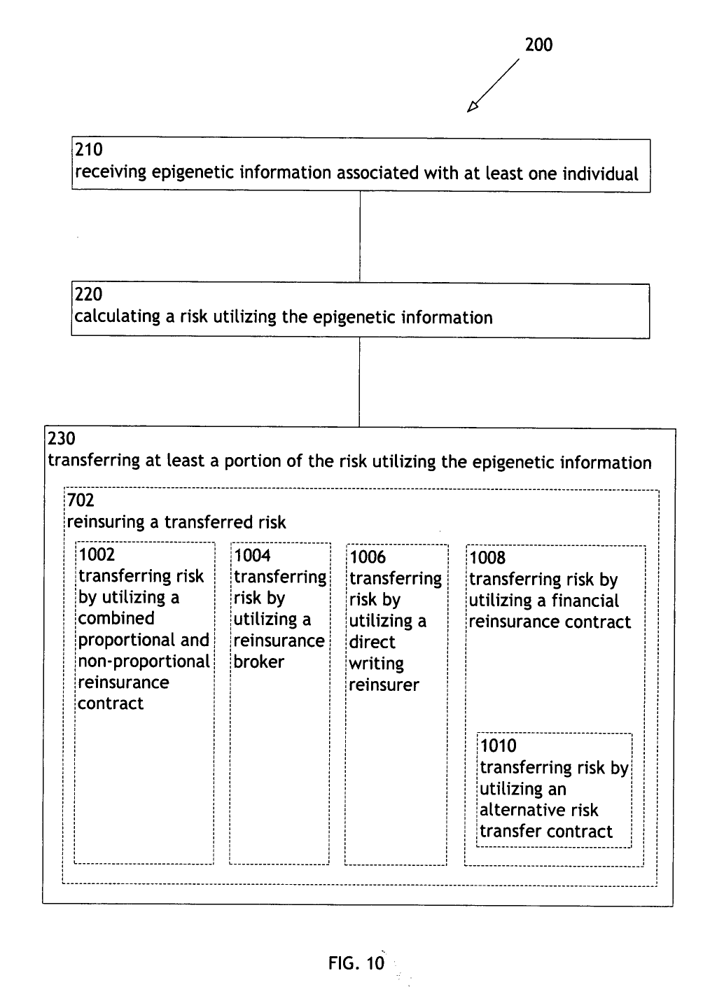

FIG. 10 illustrates alternative embodiments of the example operational flow 200 of FIG. 2. FIG. 10 illustrates example embodiments where the transferring operation 230 may include at least one additional operation. Additional operations may include an operation 1002, an operation 1004, an operation 1006, an operation 1008, and/or an operation 1010. At the operation 1002, risk may be transferred by utilizing a combined proportional and non-proportional reinsurance contract. For example, as shown in FIG. 1, the transferor module 110 may transfer at least a portion of a risk to a reinsurer in a combined proportional and non-proportional reinsurance contract, where a reinsurer proportionally assumes a risk above a certain amount with a direct insurer. Further, at the operation 1004, risk may be transferred by utilizing a reinsurance broker. For example, as shown in FIG. 1, the transferor module 110 may transfer at least a portion of a risk to a reinsurer via the reinsurance broker, who facilitates the transfer. Further, at the operation 1006, risk may be transferred by utilizing a direct writing reinsurer. For example, as shown in FIG. 1, the transferor module 110 may transfer at least a portion of a risk to a reinsurer, where the reinsurer insures the insurer directly. Further, at the operation 1008, risk may be transferred by utilizing a financial reinsurance contract. For example, as shown in FIG. 1, the transferor module 110 may transfer at least a portion of a risk to a reinsurer, where the reinsurer is involved in the capital management of the insurer. Further, at the operation 1010, risk may be transferred by utilizing an alternative risk transfer contract. For example, as shown in FIG. 1, the transferor module 110 may transfer at least a portion of a risk to a reinsurer, where at least one investor in a capital market may take a direct role in providing insurance and reinsurance protection.

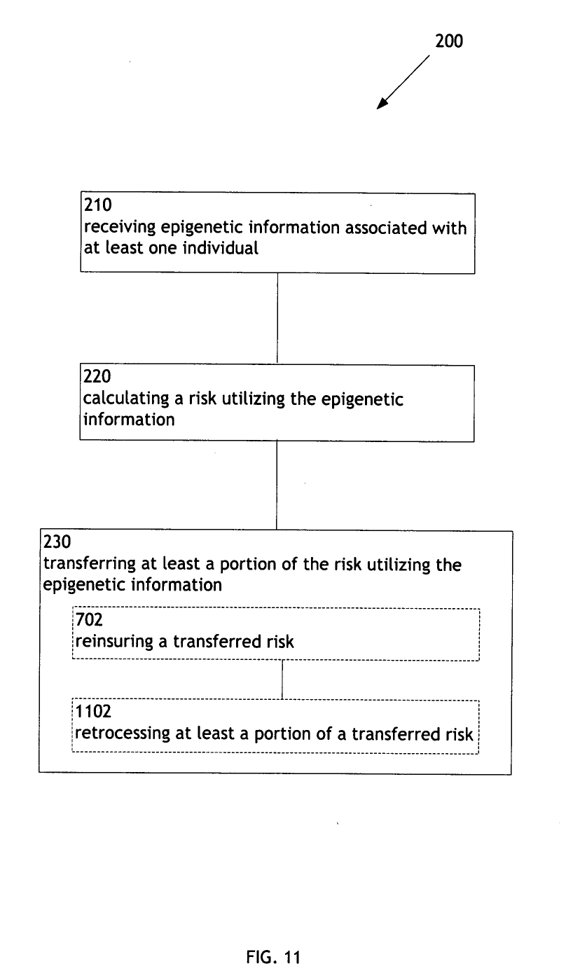

FIG. 11 illustrates alternative embodiments of the example operational flow 200 of FIG. 2. FIG. 11 illustrates example embodiments where the transferring operation 230 may include at least one additional operation. Additional operations may include an operation 1102. At the operation 1102, at least a portion of a transferred risk may be retrocessed. For example, as shown in FIG. 1, the transferor module 110 may transfer at least a portion of a risk to a first reinsurer, who subsequently transfers the portion of the risk to a second reinsurer.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated ” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent wilt be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
receiving epigenetic information associated with at least one individual;
calculating a risk utilizing the epigenetic information; and
transferring at least a portion of the risk utilizing the epigenetic information.

2-42. (canceled)

43. A system comprising:
means for receiving epigenetic information associated with at least one individual;
means for calculating a risk utilizing the epigenetic information; and
means for transferring at least a portion of the risk utilizing the epigenetic information.

44. The system of claim 43, wherein means for receiving epigenetic information associated with at least one individual comprises:
means for receiving epigenetic information in the form of a database.

45. The system of claim 43, wherein means for receiving epigenetic information associated with at least one individual comprises:
means for receiving a set amount of epigenetic information for an individual.

46. The system of claim 43, wherein means for receiving epigenetic information associated with at least one individual comprises:
means for receiving a first set of epigenetic information associated with an individual; and
means for receiving a second set of epigenetic information associated with the individual.

47. The system of claim 46, further comprising:
means for receiving a third set of epigenetic information associated with the individual.

48. The system of claim 43, wherein means for receiving epigenetic information associated with at least one individual comprises:
means for receiving information including a cytosine methylation status of CpG positions.

49. The system of claim 43, wherein means for receiving epigenetic information associated with at least one individual comprises:
means for receiving information including a histone modification status.

50. The system of claim 43, wherein means for receiving epigenetic information associated with at least one individual comprises:
means for receiving epigenetic information for a second individual.

51. The system of claim 50, wherein means for receiving epigenetic information for a second individual comprises:
means for receiving epigenetic information in the form of a database.

52. The system of claim 50, wherein means for receiving epigenetic information for a second individual comprises:
means for receiving a set amount of epigenetic information for a plurality of individuals including the at least one individual and the second individual.

53. The system of claim 50, wherein means for receiving epigenetic information for a second individual comprises:
means for receiving a first set of epigenetic information associated with the at least one individual including the second individual; and
means for receiving a second set of epigenetic information associated with the at least one individual including the second individual.

54. The system of claim 53, further comprising:
means for receiving a third set of epigenetic information associated with the at least one individual including the second individual.

55. The system of claim 50, wherein means for receiving epigenetic information for a second individual comprises:
means for receiving information including a cytosine methylation status of CpG positions.

56. The system of claim 50, wherein means for receiving epigenetic information for a second individual comprises:
means for receiving information including a histone modification status.

57. The system of claim 43, wherein means for receiving epigenetic information associated with at least one individual comprises:
means for receiving the epigenetic information on a subscription basis.

58. The system of claim 43, wherein means for calculating a risk utilizing the epigenetic information comprises:
means for underwriting a risk at least partially based on the epigenetic information.

59. The system of claim 58, wherein means for underwriting a risk at least partially based on the epigenetic information comprises:
means for correlating epigenetic information to a risk factor at least partially based on the epigenetic information.

60. The system of claim 58, wherein means for underwriting a risk at least partially based on the epigenetic information comprises:
means for underwriting a life insurance policy.

61. The system of claim 58, wherein means for underwriting a risk at least partially based on the epigenetic information comprises:
means for underwriting a health insurance policy.

62. The system of claim 58, wherein means for underwriting a risk at least partially based on the epigenetic information comprises:
means for underwriting a loan.

63. The system of claim 58, wherein means for underwriting a risk at least partially based on the epigenetic information comprises:
means for underwriting an issuance of securities.

64. The system of claim 43, wherein means for calculating a risk utilizing the epigenetic information comprises:
means for combining at least a portion of the risk from the at least one individual with a risk from a second individual.

65. The system of claim 43, wherein means for transferring at least a portion of the risk utilizing the epigenetic information comprises:
means for reinsuring a transferred risk.

66. The system of claim 65, wherein means for reinsuring a transferred risk comprises:
means for transferring risk to a treaty reinsurance contract.

67. The system of claim 66, wherein means for transferring risk to a treaty reinsurance contract comprises:
means for transferring risk to a stop-loss treaty reinsurance contract.

68. The system of claim 65, wherein means for reinsuring a transferred risk comprises:
means for transferring risk to a facultative reinsurance contract.

69. The system of claim 65, wherein means for reinsuring a transferred risk comprises:
means for transferring risk to an automatic facultative reinsurance contract.

70. The system of claim 65, wherein means for reinsuring a transferred risk comprises:
means for transferring risk to a supplemental reinsurance contract.

71. [canceled]

72. The system of claim 65, wherein means for reinsuring a transferred risk comprises:
means for transferring risk to a proportional reinsurance contract.

73-74. (canceled)

75. The system of claim 65, wherein means for reinsuring a transferred risk comprises:
means for transferring risk to a non-proportional reinsurance contract.

76. The system of claim 65, wherein means for reinsuring a transferred risk comprises:
means for transferring risk to a continuous reinsurance contract.

77. The system of claim 65, wherein means for reinsuring a transferred risk comprises:
means for transferring risk to a term reinsurance contract.

78. The system of claim 65, wherein means for reinsuring a transferred risk comprises:
means for transferring risk to an obligatory reinsurance contract.

79. The system of claim 65, wherein means for reinsuring a transferred risk comprises:
means for transferring risk by utilizing a combined proportional and non-proportional reinsurance contract.

80. The system of claim 65, wherein means for reinsuring a transferred risk comprises:
means for transferring risk by utilizing a reinsurance broker.

81. The system of claim 65, wherein means for reinsuring a transferred risk comprises:
means for transferring risk by utilizing a direct writing reinsurer.

82. The system of claim 65, further comprising:
means for retrocessing at least a portion of a transferred risk.

83. The system of claim 65, wherein means for reinsuring a transferred risk comprises:
means for transferring risk by utilizing a financial reinsurance contract.

84. [canceled]

85. A system comprising:
circuitry for receiving epigenetic information associated with at least one individual;
circuitry for calculating a risk utilizing the epigenetic information; and
circuitry for transferring at least a portion of the risk utilizing the epigenetic information.
